(19) United States
(12) Patent Application Publication
(10) Pub. No.: US 2009/0309671 A1
(43) Pub. Date: Dec. 17, 2009

(54) Integrated Microstrip Circulator and Antenna Assembly

(75) Inventors: Ryan S. Adams, Moscow, ID (US); Jeffery L. Young, Moscow, ID (US); Benton O'Neil, Moscow, ID (US)

Correspondence Address: LEE & HAYES, PLLC, 601 W. RIVERSIDE AVENUE, SUITE 1400, SPOKANE, WA, 99201, US

(73) Assignee: University of Idaho, Moscow, ID (US)

(21) Appl. No.: 12/540,327

(22) Filed: Aug. 12, 2009

Related U.S. Application Data
(63) Continuation of application No. 12/066,248.
(60) Provisional application No. 60/715,468, filed on Sep. 9, 2005.

(51) Int. Cl. H01P 1/32

(52) U.S. Cl. 333/1.1

(57) ABSTRACT

Embodiments of integrated device and associated methods of design are provided. Such embodiments include a metallic ground plane, dielectric material, ferrite puck and formed metal layer configured to define circulator and microwave device portions, or functions, within an integrated device unit. Impedance characteristics of each functional portion are determined independent of one another and are optimized with respect to each function. Respective matching network portions of each integrated device optimally couple the circulator portion with a microwave device portion and one or more connector ports. Integrated devices of the present teachings can be applied modularly at the systems level of communications, radar, and/or other contexts.

### CROSS-REFERENCE TO RELATED APPLICATIONS

This application is a continuation of U.S. non-provisional application Ser. No. 12/066,248, filed Mar. 7, 2008, the contents of which are hereby incorporated by reference in their entirety. U.S. non-provisional application Ser. No. 12/066,248 is a national stage application of International Application No. PCT/US2006/031268 filed Aug. 9, 2004, which designates the United States of America, the contents of which are hereby incorporated by reference in their entirety. The present application, U.S. non-provisional application Ser. No. 12/066,248, and International Application No. PCT/US2006/031268 claim priority to U.S. provisional application No. 60/715,468 filed Sep. 9, 2005, the contents of which are hereby incorporated by reference in their entirety.

### GOVERNMENT SPONSORED RESEARCH

This Application resulted from research supported at least in part by the Office of Naval Research under Award Number N00014-04-1-0272.

### BACKGROUND

The concept of a multifunction, adaptable or reconfigurable microwave system has received significant attention due to recent advances in integration and cost effective manufacturing processes. For example, there has been considerable interest in the integration of ferrite materials into transmit/receive antenna circuitry for communications and RADAR technologies. Ferrites are usually employed in subcircuits such as phase shifters, filters and circulators (collectively referred to herein as ferrite microwave devices).

In the case of circulator technology, one goal is to fabricate what is called a self-biased ferrite (i.e., a ferrite that remains in a saturated state without the presence of an external biasing field associated with some magnet). This fabrication is not trivial and much work on process related research is occurring in the magnetic material sciences. Concurrent research is also being conducted in the microwave and antenna communities that address new design and modeling procedures for novel integrated ferrite microstrip circuits and antenna assemblies.

The design and analysis of microstrip ferrite circulators has centered on the ferrite—namely on material selection, modeling, and geometrical layout—to achieve efficient, high isolation, and/or wideband operation. The common practice for those working in the art is to model, the ferrite geometry as a PMC/PEC closed cavity, from which the cavity's open-circuited port impedance response is determined. The response is stated in terms of network impedance parameters that are deduced from a suitable trans-impedance Green's function. From these impedance parameters and for a given frequency independent resistive load, design equations and rules are developed that determine critical parameters associated with the geometrical layout and the ferrite material. These equations and rules are typically couched in terms of isolation and bandwidth specifications.

Of concern is whether or not this common approach results in optimal performance in terms of some metric, say isolation-bandwidth product. It is desirable from an integration point of view to avoid a design process that is overly constrained by specifying loads that are resistive and frequency independent with respect to some standardized characteristic impedance. Although such constraints are common in the treatment of microwave devices and antennas as functional block units (i.e., respective parts) in some overall assemblage, such an approach is not necessarily optimal when additional constraints related to efficiency and real estate are imposed. For example, if a circulator and antenna are to be conjoined in some assembly, one optimized method for doing so is to design the impedances of each device to be the complex conjugates of each other over the frequency band of operation. To do so requires a reformulation of the circulator's impedance properties. It is important to note that, under such a method, the design of the circulator is mindful of the design of the antenna, and vice versa—the two are not optimized independent of one another.

It is desirable to design, construct and operate integrated devices wherein a circulator portion and an antenna portion (or other microwave device functionality) are concurrently optimized in regard to their respective impedances and/or other operating characteristics and are coupled in an optimal cooperative configuration.

### SUMMARY

The present teachings provide embodiments of microwave integrated devices and methods for designing the same. Such integrated devices include a microstrip ferrite circulator coupled with a planar antenna, or some other suitable microwave device. The embodiment comprises a metallic ground plane, a dielectric material supported on the ground plane, a ferrite disk or “puck” that is received within the dielectric material, and a metallic layer that overlies and makes contact with the dielectric material and ferrite puck. This metallic layer is formed to define conductive traces that guide and/or radiate microwave energy as needed for the embodiment to function per some specification. In this way, the embodiment incorporates a plurality of distinct electrical functionalities that can be viewed as cooperative portions of a whole, integrated unit (i.e., as a singular component).

The various portions of an embodiment can be optimized collectively with respect to characteristics such as bandwidth, port isolation, loss, etc., rather than individually. For example, an embodiment can include a three-port circulator portion and an antenna portion whose respective impedances are optimized in view of a predetermined metric such as bandwidth, port isolation, loss, etc. Under this example, the circulator portion is electrically coupled to the antenna portion by way of a suitable matching network portion of the embodiment. Such methods of the present teachings facilitate, for example, minimization of the size of the embodiment and improve efficiency.

These issues of optimality are addressed herein using the basic precepts of three-port network theory, whereby the characteristics of a load or other portion is not specified a priori, but is regarded as a design element. That is, immediate focus is not on the ferrite puck or its layout but on the necessary and sufficient conditions that the load impedances of a three-port network must satisfy to achieve perfect or near-ideal circulation. The required load (e.g., antenna, filter, etc.) impedances are found to be both complex and frequency dependent, which suggests that the design of these portions are part of the overall design and can be effected using an appropriate matching network and search procedure that maximizes a gain-bandwidth sort of metric. By approaching the design process in this manner, no initial restrictions are placed on ferrite puck layout, magnetization direction, or material composition; all that is required is that the port response of the ferrite network be linear, nonreciprocal and lossless.

### BRIEF DESCRIPTION OF THE DRAWINGS

FIG. 1 illustrates a lossless, non-reciprocal, three-port linear network (LNTPLN) in accordance with pertinent network theory.

FIG. 2 illustrates an LNTPLN in conjunction with matching networks labeled as M1, M2 and M3.

FIG. 3 illustrates electrical impedance equivalent models corresponding to FIG. 2.

FIG. 4 illustrates a gain-versus-frequency plot.

FIG. 5 illustrates a typical, stand-alone, microstrip circulator topology.

FIG. 6 illustrates a typical circulation impedance-versus-frequency plot.

FIG. 7 illustrates a matching network microstrip topology.

FIG. 8 illustrates a microstrip circulator with matching networks.

FIG. 9 illustrates an integrated circulator with a planar antenna in accordance with another embodiment.

FIG. 10 is a flow diagram that describes acts in accordance with one embodiment.

FIG. 11 is a flow diagram that describes acts in accordance with another embodiment.

FIG. 12 is a flow diagram that describes acts in accordance with still another embodiment.

### DETAILED DESCRIPTION

### Underlying Network Theory

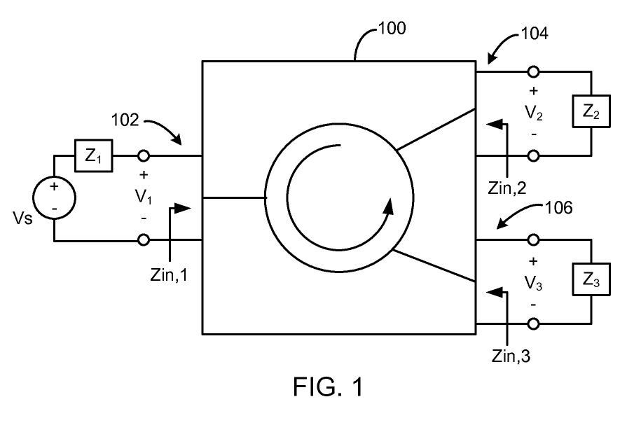

As some background for an appreciation of relevant network theory, FIG. 1 depicts a lossless, non-reciprocal, three-port linear network (hereinafter, LNTPLN) 100. The network 100 may be a complex electromagnetic system in terms of topology and material composition (e.g., ferrite), but its port response is the relevant consideration here. This port response can be obtained from one of many port parameter descriptions, such as the impedance or scattering parameter description. Whether these parameters are obtained by measurement, analysis or simulation is of no importance in this section; it is understood that they can be obtained.

The network 100 of FIG. 1 is assumed to have transmission line ports 102, 104 and 106 with a real characteristic impedance Rᵢ, for i=1, 2 and 3. As further depicted in FIG. 1, the ports (102, 104 and 106) are respectively terminated with complex load (or source) impedances Z₁, Z₂ and Z₃. Associated with these impedances are reflection coefficients Γ₁, Γ₂ and Γ₃, respectively, where:

$${Γ}_{i} = \frac{{Z}_{i} - {R}_{i}}{{Z}_{i} + {R}_{i}} ; i = 1 , 2 , 3. \qquad ( Eq . 1 )$$

The values of Z₁, Z₂ and Z₃ (or Γ₁, Γ₂ or Γ₃) are to be determined in the following analysis. If V⁺ and V⁻ are the incident and reflected voltage vectors at the terminal plane of the ports and are given by V⁺=[V₁⁺, V₂⁺, V₃⁺]^{t} and V⁻=[V₁⁻, V₂⁻, V₃⁻]^{t}, then by definition:

V⁻=SV⁺ (Eq. 2)

where S is the scattering matrix:

$$S = [ \begin{matrix}{S}_{11} & {S}_{12} & {S}_{13} \\ {S}_{21} & {S}_{22} & {S}_{23} \\ {S}_{31} & {S}_{32} & {S}_{33}\end{matrix} ] \qquad ( Eq . 3 )$$

Here, Sᵢⱼ is the transmission scattering parameter between ports i and j for all i≠j; Sᵢᵢ is the reflection coefficient at port i. For reciprocal networks, the scattering matrix satisfies the symmetry equation S=RₒS^{t}Gₒ, where:

$${R}_{o} = [ \begin{matrix}{R}_{1} & 0 & 0 \\ 0 & {R}_{2} & 0 \\ 0 & 0 & {R}_{3}\end{matrix} ] \qquad ( Eq . 4 )$$

and Gₒ=Rₒ⁻¹ (i.e., inverse of the matrix Rₒ). For lossless networks, S=RₒS^{t}GₒS*=U, where U is the identity or unity matrix.

In the interest of understanding, assume that an incident wave V₁⁺ impinges on port 102 of FIG. 1 and is produced by a source VS whose internal reflection coefficient is Γ₁. When ports 104 and 106 are respectively loaded with Z₂ and Z₃, waves leaving these ports will be reflected into the circuit in accordance with the relationships V₂⁺=Γ₂V₂⁻, and V₃⁺=Γ₃V₃⁻. It follows from the definition of the S matrix that V⁻ is related to V₁⁺ via the following matrix equation:

$$[ \begin{matrix}1 & - {S}_{12} {Γ}_{2} & - {S}_{13} {Γ}_{3} \\ 0 & 1 - {S}_{22} {Γ}_{2} & - {S}_{23} {Γ}_{3} \\ 0 & - {S}_{32} {Γ}_{2} & 1 - {S}_{33} {Γ}_{3}\end{matrix} ] [ \begin{matrix}{V}_{1}^{-} \\ {V}_{2}^{-} \\ {V}_{3}^{-}\end{matrix} ] = [ \begin{matrix}{S}_{11} {V}_{1}^{+} \\ {S}_{21} {V}_{1}^{+} \\ {S}_{31} {V}_{1}^{+}\end{matrix} ] \qquad ( Eq . 5 )$$

Continuing the example and solving for V₂⁻, we obtain:

$$\frac{{V}_{2}^{-}}{{V}_{1}^{+}} = \frac{{S}_{21} ( 1 - {S}_{33} {Γ}_{3} ) + {S}_{31} {S}_{23} {Γ}_{3}}{( 1 - {S}_{22} {Γ}_{2} ) ( 1 - {S}_{33} {Γ}_{3} ) - {S}_{23} {S}_{32} {Γ}_{2} {Γ}_{3}} \qquad ( Eq . 6 )$$

From the previous equation (Eq. 6), it can be seen that a null response at port 104 of FIG. 1 is obtained when V₂⁻=0, or when:

$${Γ}_{3} = \frac{{S}_{21}}{{S}_{21} {S}_{33} - {S}_{31} {S}_{23}} \qquad ( Eq . 7 )$$

With V₂⁻ set to zero, the port response of ports 102 and 106 is given by:

$$[ \begin{matrix}1 & - {S}_{12} {Γ}_{3} \\ 0 & 1 - {S}_{33} {Γ}_{3}\end{matrix} ] [ \begin{matrix}{V}_{1}^{-} \\ {V}_{3}^{-}\end{matrix} ] = [ \begin{matrix}{S}_{11} {V}_{1}^{+} \\ {S}_{31} {V}_{1}^{+}\end{matrix} ] \qquad ( Eq . 8 )$$

Solving for V₁⁺/V₁⁺, which is the input reflection coefficient at port 102 of FIG. 1 (i.e., Γ_{in,1}), it is obtained that:

$${Γ}_{in , 1} ≡ \frac{{V}_{1}^{-}}{{V}_{1}^{+}} = \frac{{S}_{11} ( 1 - {S}_{33} {Γ}_{3} ) + {S}_{31} {S}_{13} {Γ}_{3}}{1 - {S}_{33} {Γ}_{3}} \qquad ( Eq . 9 )$$

Substitution of Eq. 7 into Eq. 9 yields:

$${Γ}_{in , 1} = \frac{( {S}_{11} {S}_{23} - {S}_{13} {S}_{21} )}{{S}_{23}} \qquad ( Eq . 10 )$$

A similar analysis can be carried out as the one above by driving port 104 of FIG. 1 with an incident wave while forcing port 106 to have a null response. The required load reflection coefficient for this situation is:

$${Γ}_{1} = \frac{{S}_{32}}{{S}_{32} {S}_{11} - {S}_{31} {S}_{12}} \qquad ( Eq . 11 )$$

The corresponding input reflection coefficient at port 104 is Γ_{in,2}, where:

$${Γ}_{in , 2} = \frac{( {S}_{22} {S}_{31} - {S}_{21} {S}_{32} )}{{S}_{31}} \qquad ( Eq . 12 )$$

Likewise, for excitation of port 106 of FIG. 1 and isolation of port 102,

$${Γ}_{2} = \frac{{S}_{13}}{{S}_{13} {S}_{22} - {S}_{12} {S}_{23}} \qquad ( Eq . 13 )$$

and

$${Γ}_{in , 3} = \frac{( {S}_{33} {S}_{12} - {S}_{32} {S}_{13} )}{{S}_{12}} \qquad ( Eq . 14 )$$

Thus, FIG. 1 depicts a case of counter-clockwise circulation within the LNTPLN 100.

From equations 7, 11 and 13 above, the required load (e.g., an antenna, a microwave device, etc.) impedance at each of the three ports 102-106 can be found using equation 1. These same equations 7, 11 and 13 establish the necessary conditions for perfect isolation. To be assured that these equations are also sufficient for perfect circulation, power transfer through the network is examined as described below.

One of ordinary skill in the art will recall that if the network is lossless, the scattering matrix has the property RₒS^{t}GₒS*=U. This matrix equation can be used to find S* in terms of S by solving the equation S*=(RₒS^{t}Gₒ)⁻¹. For example:

$${S}_{11}^{*} = \frac{( {S}_{22} {S}_{33} - {S}_{23} {S}_{32} )}{{Δ}_{s}} \qquad ( Eq . 15 )$$

and

$${S}_{21}^{*} = \frac{( {R}_{2} / {R}_{1} ) ( {S}_{13} {S}_{32} - {S}_{12} {S}_{33} )}{{Δ}_{s}} \qquad ( Eq . 16 )$$

Where Δₛ=det{S}. By inserting expressions like equations 15 and 16 into the conjugate of equation 10, the following is obtained:

$${Γ}_{in , 1}^{*} = \frac{( {S}_{11}^{*} {S}_{23}^{*} - {S}_{13}^{*} {S}_{21}^{*} )}{{S}_{23}^{*}} = \frac{{S}_{32}}{{S}_{32} {S}_{11} - {S}_{31} {S}_{12}} ≡ {Γ}_{1} \qquad ( Eq . 17 )$$

Similar manipulations yield:

Γ*_{in,2}Γ₂

Γ*_{in,3}=Γ₃ (Eq. 18)

Equations 17 and 18 above describe maximum power transfer between the network 100 of FIG. 1 and the load (or source) impedances (e.g., Z₁, Z₂ and Z₃). For example, consider FIG. 1 when the load (i.e., Z₂, Z₃) and source (i.e., Z₁) impedances are determined by Eqs. 7, 11 and 13 above. Maximum power transfer will occur between the source Vₛ and the LNTPLN 100 at port 102 and between the LNTPLN 100 and the load Z₃ at port 106. Since port 104 is isolated and since the network 100 is lossless, it is concluded that maximum power transfer will occur between the source Vₛ at port 102 and the load Z₃ at port 106. Similar arguments can be made when the other ports (104, 106) are excited.

The previous statements can be summarized in terms of the following theorem:
Circulator Theorem The necessary and sufficient conditions for perfect circulation of a three-port network are: 1) non-reciprocity (i.e., S≠RₒS^{t}Gₒ); 2) losslessness (i.e., RₒS^{t}GₒS*=U); and 3) terminal load reflection coefficients determined by Eqs. 7, 11 and 13 above.
   Although not discussed herein, the non-reciprocity clause assures that the computed reflection coefficients are not unity in magnitude.

To reverse the direction of circulation (i.e., opposite of that shown in FIG. 1) such that port 106 is the isolation port and port 104 is the through port when port 102 is the excitation port, it can be shown using similar techniques described earlier that:

$${Γ}_{2}^{′} = \frac{{S}_{31}}{{S}_{31} {S}_{22} - {S}_{21} {S}_{32}} \qquad ( Eq . 19 )$$

where Γ₂ is the reflection coefficient of the load Z₂ at port 104. In the same manner by which equation 18 was derived, it is noted that:

(Γ′_{in,2})=Γ₂ (Eq. 20)

However, an examination of Eqs. 12 and 19 above reveals that:

$${Γ}_{2}^{′} = \frac{1}{{Γ}_{in , 2}} \qquad ( Eq . 21 )$$

Using equations 18, 20 and 21 as a foundation, it is demonstrable by inductive reasoning that:

$${Γ}_{i}^{′} = \frac{1}{{Γ}_{in , i}} = {( {Γ}_{in , i}^{′} )}^{*} = \frac{1}{{Γ}_{i}^{*}} \qquad ( Eq . 22 )$$

for i=1, 2 and 3.

When rotational symmetry exists within the network 100 of FIG. 1, such that R₁=R₂=R₃≡Rₒ and:

S₁₁=S₂₂=S₃₃

S₂₁=S₃₂=S₁₃

S₃₁=S₂₃=S₁₂ (Eq. 23)

the equations for counter-clockwise circulation reduce to:

$${Γ}_{1} = {Γ}_{2} = {Γ}_{3} = \frac{{S}_{21}}{{S}_{11} {S}_{21} - {S}_{31}^{2}} \qquad ( Eq . 24 )$$

From these equations, and from equation 1 above,

$${Z}_{1} = {Z}_{2} = {Z}_{3} = {R}_{o} \frac{{S}_{21} ( {S}_{11} + 1 ) - {S}_{31}^{2}}{{S}_{21} ( {S}_{11} - 1 ) - {S}_{31}^{2}} \qquad ( Eq . 25 )$$

For clockwise rotation (not shown in FIG. 1),

$${Γ}_{1}^{′} = {Γ}_{2}^{′} = {Γ}_{3}^{′} = \frac{{S}_{31}}{{S}_{11} {S}_{31} - {S}_{21}^{2}} \qquad ( Eq . 26 )$$

and

$${Z}_{1}^{′} = {Z}_{2}^{′} = {Z}_{3}^{′} = {R}_{o} \frac{{S}_{31} ( {S}_{11} + 1 ) - {S}_{21}^{2}}{{S}_{31} ( {S}_{11} - 1 ) - {S}_{21}^{2}} \qquad ( Eq . 27 )$$

For perfect circulation to exist it is imperative that the load impedances (e.g., Z₁, Z₂, Z₃) or the reflection coefficients (e.g., Γ₁, Γ₂, Γ₃) be constructed in accordance with the equations provided above. However, rare is the case where sources and loads, such as antennas and amplifiers, have the correct impedance, as referenced to the LNTPLN 100 of FIG. 1. To create this correct impedance, lossless matching networks are required to convert source and load impedances to the correct LNTPLN 100 impedance, as discussed in greater detail below.

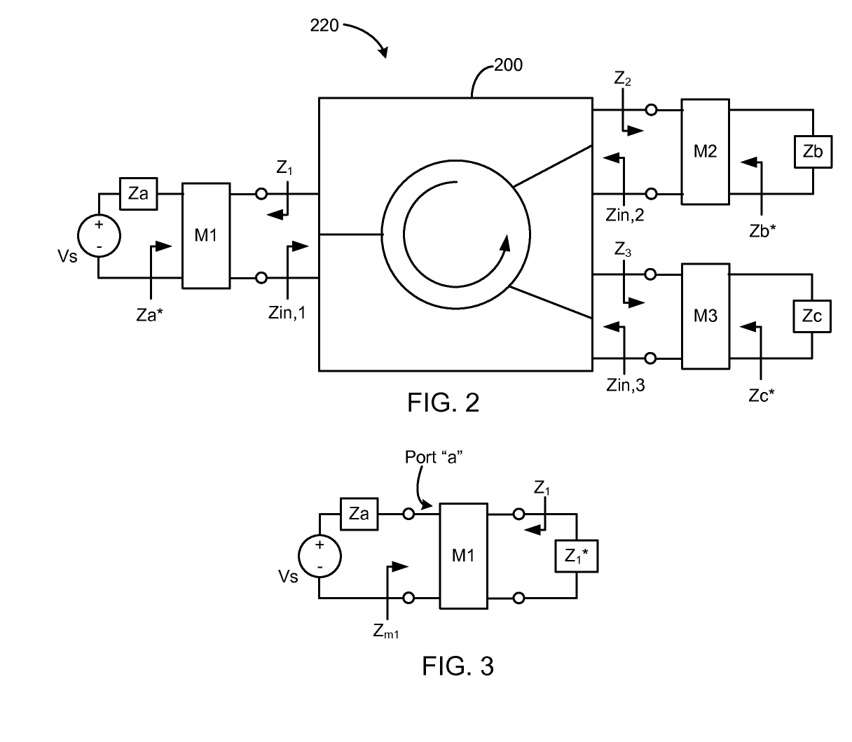

Reference is now made to FIG. 2, which depicts a three-port network (LNTPLN) 200 generally as introduced above in regard to FIG. 1. As depicted in FIG. 2, matching networks labeled M1, M2 and M3 and, together with the LNTPLN 200, are the functional building blocks of an overall circulator 220. As further depicted in FIG. 2, the load (source) impedances of M1, M2 and M3 are Zₐ, Z_{b} and Z_{c}, respectively, and are assumed to be frequency-dependent and known a priori. Separate designations (i.e., letters versus numbers) for these load impedances and matching networks are used to indicate that the matching networks and loads can be (and often are) different from each other.

As indicated in FIG. 2, M1 is loaded with an equivalent impedance of Z_{in,1} and is designed to have an input impedance of Zₐ*. This requirement will assure maximum power transfer from the source (Vₛ) to the input of M1. This power must be transferred to the LNTPLN 200, since M1 is lossless, which suggests that maximum power transfer exists between M1 and the LNTPLN 200. Therefore, on the basis of maximum power transfer, the impedance looking into the output of M1 must be Z*_{in,1}, or Z₁, as confirmed by Eq. 22 above. From this discussion, it suffices to say that the design of M1 has a particular input impedance for an assumed load, as depicted in FIG. 3. Similar arguments apply to M2 and M3.

One way to accomplish the design of a matching network, particularly for wideband operation (described in further detail below), is to maximize its bandwidth for a given acceptable transducer power gain, G_{T}. With reference to FIG. 3, the transducer power gain between the source Vₛ at port “a” of the matching network M1 and the load Z₁* is defined as:

$${G}_{T} = \frac{{P}_{1}}{{P}_{a}} \qquad ( Eq . 28 )$$

where Pₐ is the maximum available, time-averaged power of source Vₛ at port “a” with a known internal impedance Zₐ, and P₁ is the time averaged power absorbed by the load Z₁*. Since the matching network M1 is lossless, P₁=Pₘ₁, where Pₘ₁ is the time-averaged power delivered to M1—or, equivalently, as absorbed in Zₘ₁—which is the input impedance of M1. Thus,

$${G}_{T} = \frac{{P}_{m 1}}{{P}_{a}} \qquad ( Eq . 29 )$$

A straightforward circuit analysis can be conducted to relate G_{T} to the impedances of the circuit:

$${G}_{T} = 1 - {\vert \frac{{Z}_{m 1} - {Z}_{a}^{*}}{{Z}_{m 1} + {Z}_{a}} \vert}^{2} \qquad ( Eq . 30 )$$

The second term on the right is regarded as the power rejected by the network for one unit of power supplied. Moreover, if Zₐ of FIG. 3 is real and is correlated to the characteristic impedance of a transmission line associated with the terminals of the source (Vₛ), then the second term is the magnitude squared of the classical reflection coefficient of transmission line theory. From that point of view, the second term is the total power reflected by M1 back to the source.

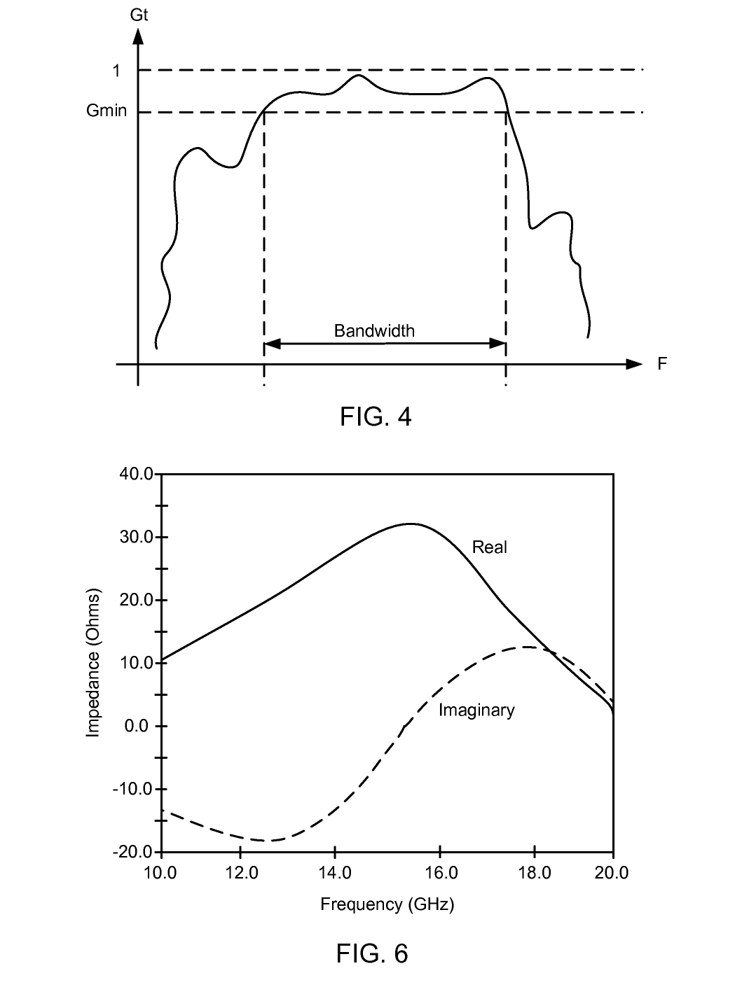

Assume that the topology of M1 is known a priori and consists of lossless elements E_{d} such as inductors, capacitors, transmission lines, cavities, etc. Here d=1, 2, . . . , D, where D is the total number of degrees of freedom. The dth element has a domain of values that spans Ω_{d}. The total domain size is Ω, where Ω=Ω₁×Ω₂× . . . ×Ω_{D}. In accordance with the present teachings, M1 is designed by searching the parameter space Ω that results in an impedance Zₘ₁ that maximizes power bandwidth for a minimal acceptable value of G_{T}, denoted as Gₘᵢₙ. The definition of bandwidth in terms of Gₘᵢₙ is shown in the sketch of FIG. 4. How this search is accomplished is not the focus of these teachings. One of ordinary skill in the art of optimization procedures can appreciate that some search (e.g. universal, genetic algorithms, particle swarm, etc.) can be conducted that will result in the optimal design of M1 per the stated metric.

It should be noted that the design goal of maximizing bandwidth for a given Gₘᵢₙ is consistent with the observation that bandwidth is maximized by striving to achieve a transducer power gain closer to Gₘᵢₙ rather than to unity. From this point of view, Chebyshev and Butterworth responses are not invoked, since their responses achieve unity values at select frequencies. According to Bode-Fano (R. M. Fano, Theoretical limitations on the broadband matching of arbitrary impedances, J. Franklin Institute, Vol. 249, pp. 57-83, 1950.), the limiting factor in achieving wideband matching network design is the equivalent Q of the load Z₁*. Since high-Q loads are difficult to match over a wideband using only a few degrees of freedom, a critical aspect of circulator design is finding the right materials and topology for the LNTPLN (e.g., 100, 200 of FIGS. 1 and 2, etc.) that will reduce Q. Of course, for high-Q loads more degrees of freedom can be used to achieve a wider bandwidth, but doing so decreases the efficiency of a practical, physical (vs. an ideal, lossless) matching network (i.e., M1, M2, etc.), increases the overall size of the device and increases the search time.

Validation of the matching network design is accomplished by performing a voltage and current analysis of the entire network of FIG. 2. For real-valued impedances (i.e., wherein no imaginary component is present) Zₐ, Z_{b} and Z_{c} that represent the characteristic impedances of the loading transmission lines, the voltage and current responses can then be used to deduce the scattering parameters (Sᵢⱼ) of the entire system. Since the matching networks (e.g., M1, M2, etc.) do not by design realize the exact impedance for perfect circulation, the system response will deviate from the expected response. This deviation can be mitigated by increasing Gₘᵢₙ to a value closer to unity, but doing so will compromise the methods ability to find an acceptable solution.

It is important to note that most ferrite elements (i.e., pucks) including many, if not most, of those contemplated by the present teachings, require a biasing network in order to achieve and/or maintain full saturation and function as intended. While not depicted in the present drawings, one of ordinary skill in the related arts can appreciate that such a biasing network can be designed and/or implemented in accordance with known techniques, and applied as needed within the scope of the present teachings. Accordingly, it is to be assumed that exemplary embodiments presented herein are equipped with an appropriate biasing network as needed such that the corresponding ferrite puck is fully saturated with an internal static magnetic intensity that is approximately zero. This is necessary in order to operate the ferrite well below ferromagnetic resonance and to mitigate ferrite losses.

### Exemplary Embodiment Elements and Layout

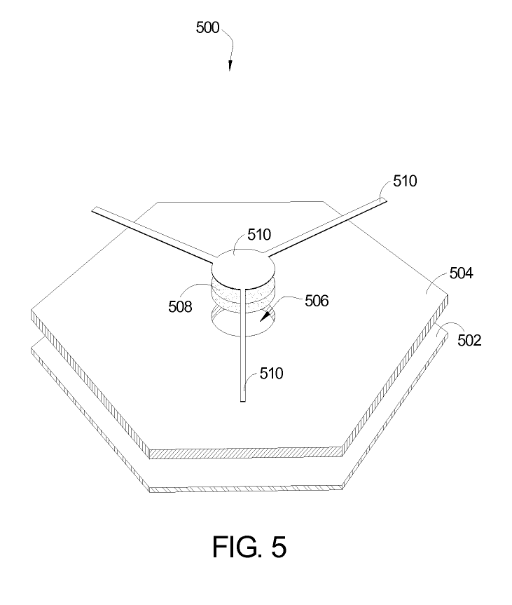

Reference is now made to FIG. 5, which depicts an exploded, isometric schematic view of a typical microstrip circulator (also hereinafter, device) 500 according to the present teachings. The device 500 includes a metallic ground plane 502. The device 500 also includes a dielectric material 504 defining an aperture 506. The dielectric 504 is contactingly supported by the metallic ground plane 502 when the device 500 is assembled as a unitary structure.

The integrated device 500 of FIG. 5 further includes a ferrite puck 508. The ferrite puck 508 is supportingly received within the aperture 506 of the dielectric 504 when the device 500 is in fully assembled form. The device 500 also includes a metallic trace or layer structure 510 that overlies and is contactingly supported by the ferrite puck 508 and the dielectric 504. The metallic trace 510 is typically defined by a formed (i.e., patterned) copper layer. Further description of the elements 502-510 of FIG. 5 is provided below.

Consideration is now given to two exemplary embodiments of the present teachings: 1) a stand-alone, microstrip circulator; and 2) an integrated planar Yagi antenna with a microstrip circulator. For purposes of example, it is assumed that the center frequency of operation is selected to be in the vicinity of about 14 GHz in both cases. With reference to FIG. 5, it is further assumed that the geometry and magnetic properties of the ferrite puck 508 have been determined through some search procedure. In both examples, the Trans-Tech TT1-2000 bulk magnesium ferrites 508 were found to be optimal. These ferrite elements are available from Trans-Tech, Inc., 5520 Adamstown Road, Adamstown, Md., 21710, USA. The ferrite pucks 508 of this ongoing example are defined by the following characteristics:

4πMₛ=2000 G; ΔH=300 Oe; ∈_{f}=12.4; tan δ_{f}=0.00025; and

H_{c}=1.0 Oe.

To maintain saturation and a zero internal magnetic DC field, an external biasing field is of strength 17100e is used. The ferrite puck 508 (FIG. 5) in each instance is of radius 1.75 mm and is embedded in a uniform dielectric 504 of:

Permittivity=4.5; loss tangent=0.0002; and thickness=0.5 mm.

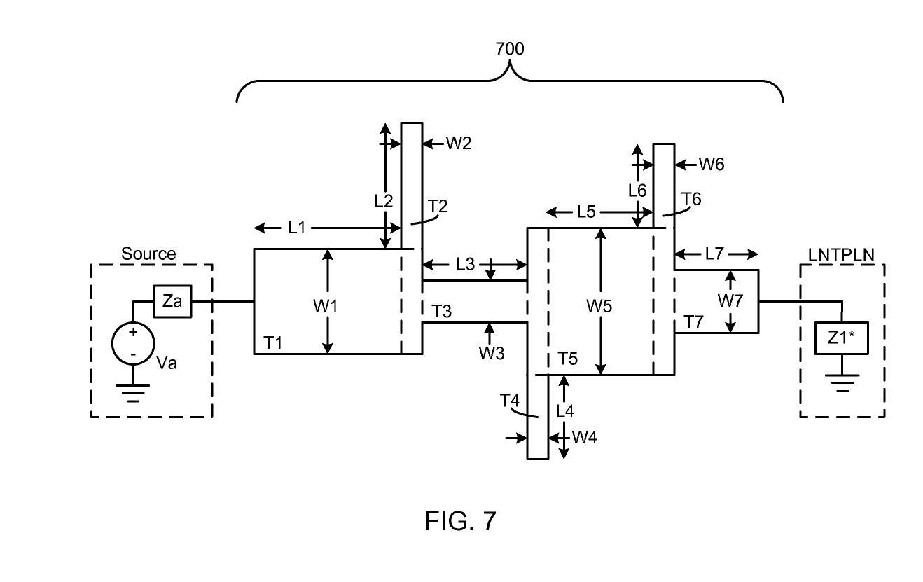

The dielectric 504 and ferrite puck 508 combination is clad, or supported, by a copper ground plane 502. Copper traces are patterned on top to form a microstrip layout defined by the metal layer 510. The coupling angle (ψ, not shown) determines the width (W7, refer to FIG. 7) of the conjoining microstrip lines defined by the metal layer 510 as:

W=2α sin ψ, wherein: ψ=0.80r for these examples.

### Exemplary Design for a First Embodiment Integrated Device

The description above regarding FIG. 5 provides a starting point with respect to physical layout and properties of various integrated device embodiments according to the present teachings. As such embodiments include a circulator (e.g., the LNTPLN 100 of FIG. 1, etc.), the next step in the design process is determine the impedances Z₁, Z₂ and Z₃ according to the network theory discussion above. Since an LNTPLN embodiment of the present teachings is geometrically symmetrical, it suffices to calculate only one such impedance (e.g., Z₁, etc.) according to equation 25 above from the network S-parameters (transmission scattering parameters) for the particular embodiment under consideration.

To find the S-parameters of an LNTPLN (e.g., 100 and 200 of FIGS. 1 and 2, etc.), a full-wave electromagnetic solver is used to simulate the circuit as represented by FIG. 5. For purpose of this investigation, Ansoft's HFSS finite element solver suffices. HFSS is available from Ansoft Corp., Pittsburgh, Pa., USA. For such an approach, a Landau-Lifshitz model of the ferrite puck 508 is required as part of the solver's functionality. A model of the aforementioned type is phenomenological and approximate, which suggests that errors in the solver's data will be primarily model-related rather than discretization-related—noting, of course, that the latter can be mitigated by using high quality basis functions and a highly resolved grid. Equally valid, but not used herein, is to perform a network measurement; the measurement option eliminates all ambiguity of the ferrite puck 508 model, but requires a new prototype whenever any of the parameters of the circulator (i.e., LNTPLN) are changed. Whether the data is obtained by simulation or measurement, it is done so at some terminal plane where the matching network is to be attached. Herein, that plane is assumed to be tangential to the puck's (508) radial surface.

The exemplary circulation impedance data Z₁, is plotted in FIG. 6. Therein, it is seen that resonance occurs around 15 GHz and the resonant impedance is about 32 Ohms. The imaginary part ranges from about −12 Ohms to about 12 Ohms over the 10 to 20 GHz band. The shape of these curves suggests that a fairly simple matching network (e.g., M1-M3 of FIG. 2, etc.) can be invoked to realize a 50 Ohm impedance over a 3 GHz to 4 GHz bandwidth.

Next, the design of a stand-alone 50 Ohm circulator is considered. With Z₁ impedance data known from FIG. 6, a suitable matching network that uses Z₁* as a load, and transforms it into a 50 Ohm input impedance, needs to be designed. In terms of FIG. 2, Zₐ=Z_{b}=Z_{c}=50 Ohms. For purposes herein, reference is now made to FIG. 7, which depicts a general matching network microstrip topology (hereinafter, matching network) 700. For this network 700, the degrees of freedom are the lengths (L) and widths (W) of the various transmission lines, except for the line connected to the ferrite puck (e.g., 508 of FIG. 5, not shown in FIG. 7); the width of this line is: 2α sin ψ, and is fixed by the specified coupling angle and ferrite puck radius. It should be noted that the traditional impedance transformer is a special case of the topology of FIG. 7 when the stub lengths (e.g., T2, T4 and T6) are zero.

A search algorithm (e.g., universal, genetic algorithm, etc.) is devised by which the widths (W) and the lengths (L) of the microstrip lines of M1 are adjusted as the transducer power gain of equation 30 above is monitored. For this example, the search is completed when the algorithm finds the maximum bandwidth about the center frequency of 14 GHz for a minimal acceptable transducer power gain of 0.99 (or 20 dB return loss). Referring to FIG. 7, the resulting lengths (L) and widths (W) from this exemplary search are:

W3=0.9400 mm; W4=0.2157 mm; W5=1.1172 mm;

W6=0.2157 mm; W7=2.5100 mm; L7=0.2600 mm; L6=0.3472 mm;

L5=6.7380 mm; L4=0.9023 mm; and L3=12.4729 mm;

the T1 and T2 lines do not exist (are not formed or used) in this exemplary design.

In this way, a portion of the metal layer 510 of FIG. 5 can be configured so as to define a network matching portion of an integrated device.

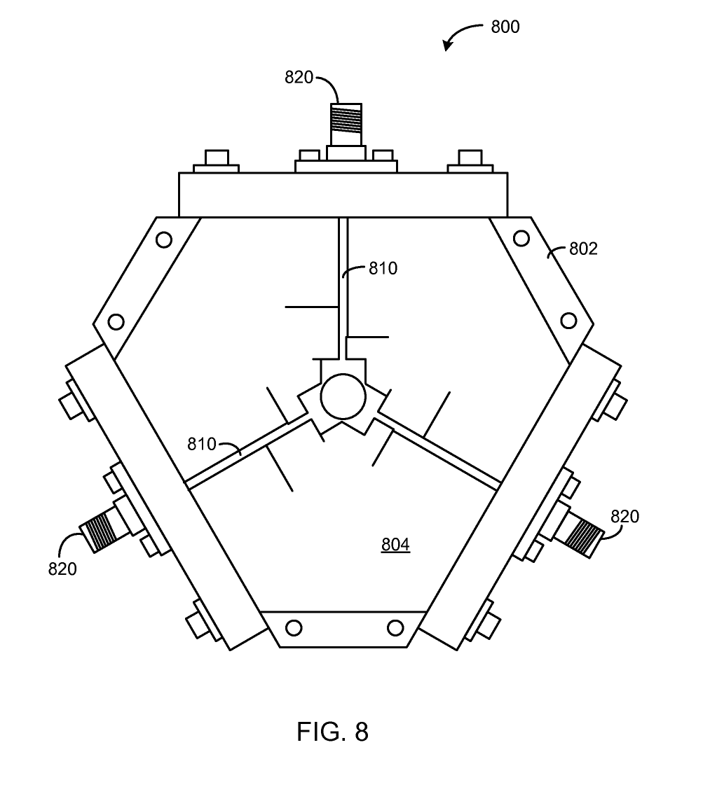

The matching networks just designed and the LNTPLN are next conjoined to form the circulator and the resulting circulator is validated using simulation tools prior to fabrication. An embodiment of a completed, three-port integrated device 800 in accordance with the foregoing design procedure is depicted in plan view in FIG. 8. The device 800 includes copper ground plane (not shown), dielectric material 804, formed metal layer (i.e., traces, or microstrips) 810 and a plurality of connection ports 820. The connection ports 820 allow the three respective ports of integrated device 800 to be coupled to external circuitry for testing, operation, etc. The device 800 is shown in its test adapter 802.

A prototype embodiment of integrated device was constructed and tested by the inventors in accordance with design procedure described above and as depicted by FIG. 8. Such testing indicated that the 20 dB design goal was indeed reached in the passband. Both simulation and experimental data showed approximately 4.1 GHz of bandwidth (using a 2:1 VSWR specification) about the 14 GHz center frequency. The insertion loss was measured to be about 1.3 dB in the passband, whereas the simulation predicted 0.9 dB. The difference between the two is believed to be the result of connector loss, which was not modeled in the simulation. Finally, any major discrepancies in the two data sets is believed to be the result of the inadequacy of the ferrite model in the solver and the electrical artifacts induced by the end launch connectors. None the less, satisfactory performance was achieved.

### Exemplary Design for a Second Embodiment Integrated Device

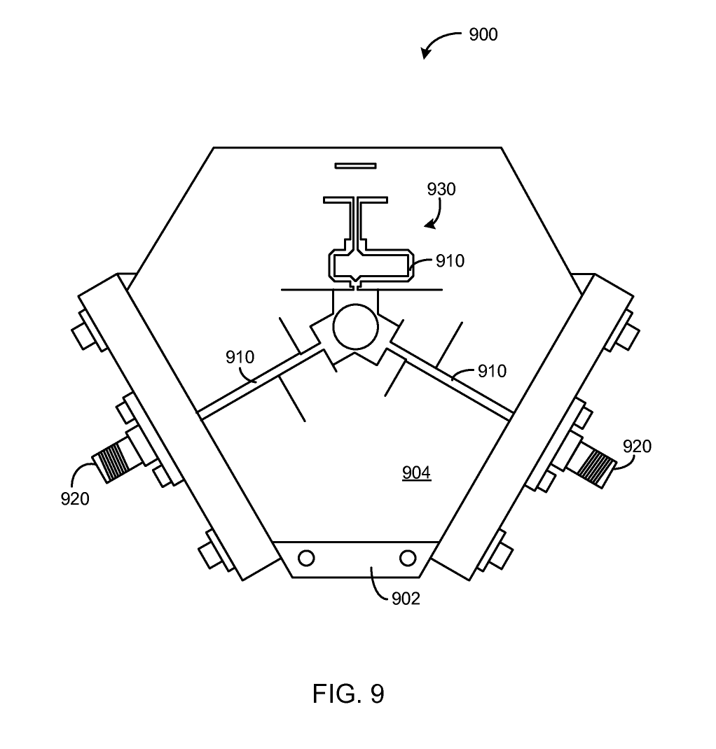

Next, the design of an integrated circulator and antenna is considered in accordance with the present teachings. For this example, a wideband, planar Yagi antenna with a single director element was selected for incorporation within an integrated device embodiment. Attention is now directed to FIG. 9, which depicts an integrated device 900 in plan view. The design procedure for this exemplary embodiment is exactly like that of the discussion above with one key, difference: in this case, we are using antenna impedance data, instead of 50 Ohms, for one of the port matching networks. This data corresponds to Zₐ in FIG. 3; for the other two ports Z_{b}=Z_{c}=50 Ohms, as in the previous exemplary embodiment. That is, for the circulator/antenna port the matching network is one of a complex-to-complex impedance match. It is stressed that this is fundamentally different from designing the circulator and antenna separately to be both 50 Ohm devices, as in the first embodiment.

For this one port (refer also to FIG. 7):

W3=1.2000 mm; W4=0.2157 mm; W5=0.3794 mm;

W6=0.2157 mm; W7=2.5100 mm; L3=0.5037 mm;

L4=6.9490 mm; L5=0.2630 mm; L6=4.5436 mm; and

L7=1.2184 mm; lines T1 and T2 are not formed or used in this exemplary design.

The other two ports have the same matching networks as described previously for the stand alone circulator (device 800 of FIG. 8). Note that, in this example, the LNTPLN of FIG. 1 is topologically symmetric, but the matching network M1 is different from M2 and M3. This type of port flexibility points to one of the key attributes of the design methodology of the present teachings.

The final fabricated integrated device 900 is shown in FIG. 9. The integrated device 900 includes copper ground plane (not shown), dielectric material 904, formed metal layer (i.e., traces, or microstrips) 910 and a pair of threaded electrical connector ports 920. It is noted that the metal layer 910 further defines a Yagi antenna portion 930. The device is shown in its test adapter 902. Testing of the constructed device 900 indicated that the measured return loss is about 18 dB in the passband, which was 2 dB lower than the 20 dB design goal. Similarly, the measured isolation was about 17 dB, which is off by 3 dB. The measured insertion loss was around 1.5 dB and is quite flat across the band. Using a 2:1 VSWR bandwidth specification, the frequency span of operation was about 12.3 GHz to 16.3 GHz.

The major discrepancy between simulation data and measured (empirical) data occurs in the passband. It is believed that this discrepancy is due to the test fixture and biasing magnet interfering with the near field radiation; both of these effects are not part of the simulation model. It is also stressed that the comparisons between the two data sets of the passband are comparisons of the logarithms of small numbers, which exacerbates the comparison otherwise not seen in linear plots. The radiation pattern was not measured, but simulation data of the entire assembly shows little deviation with the measured data of.

### Flow of Design Methodology

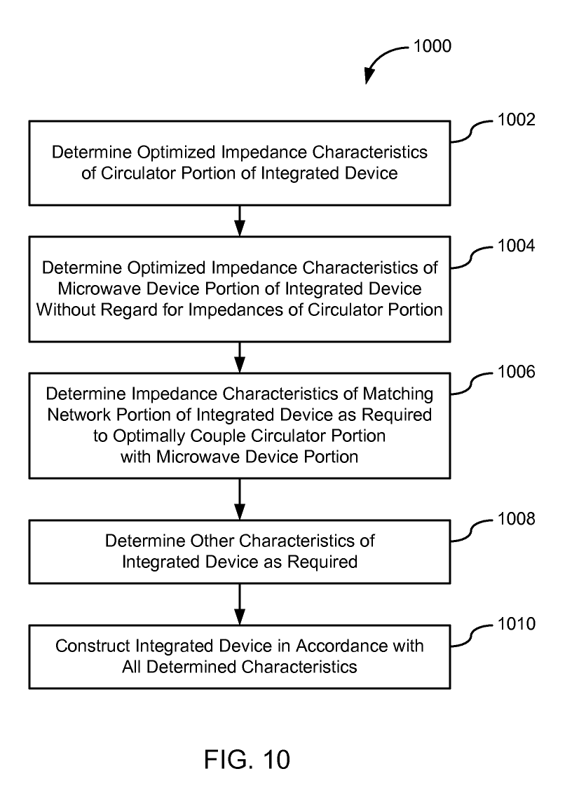

FIG. 10 depicts a flowchart 1000 including general design method steps according to various embodiments of integrated device of the present teachings. The general topology and elemental constituency of such an integrated device is, for example, as depicted in FIG. 5. The method of flowchart 1000 includes step 1002, wherein one or more optimized impedance characteristics for a circulator portion of an integrated device are determined. These impedance characteristics are considered design elements and are not known a prior—that is, these impedance characteristics are not dictated or driven by other pre-existing conditions or criteria. Thus, the impedance characteristics of the circulator portion can by optimized and selected independent of any common convention (e.g., 50 Ohms, etc,) and/or without regard for the impedance(s) of other portions of the resulting integrated device.

At step 1004 of FIG. 10, optimized impedance characteristics of a microwave device portion of the integrated device are determined (i.e., selected). A microwave device portion can be defined by, for example, a filter, a mixer, an amplifier, a phase shifter, etc., or any other microwave functionality suitable for incorporation within the integrated device embodiment. As in the case of step 1002 above, such impedances are determined independently and without regard for the impedance(s) of other, cooperative portions of the integrated device.

Next, in step 1006, the impedance characteristics of a matching network portion are determined. The matching network portion is used to couple a transmission line port of the circulator portion (as determined in step 1002 above) to the microwave device portion just determined. Such impedances of the matching network are generally respectively determined in accordance with the complex conjugates of the impedance to be coupled thereby. Other design and coupling strategies can also be used. In any case, the matching network portion impedances are determined so as provide optimal coupling between the circulator portion and the microwave device portion of the resulting integrated device.

In step 1008 of FIG. 10, other characteristics of the integrated device are determined as required and/or desired. For example, other matching network portions corresponding to connections between respective transmission line ports of the circulator portion and external interface ports of the integrated device can be determined.

Thereafter, in step 1010 of FIG. 10, the final integrated device is constructed in accordance with the all of the characteristics (impedances, etc.) determined in steps 1002-1008 above. Thus, such an integrated device would typically comprise a metallic ground plane of copper or another suitable material, a dielectric layer of material supported on the ground plane, a ferrite puck received within the dielectric, and a copper (or other) metal layer (microstrip) layout in contacting support with the ferrite puck and dielectric material. Other elements and features such as threaded connectors, mounting holes, etc., can also be incorporated. In any case, the final integrated device incorporates circulator and other microwave device portions (i.e., functions) sharing, or common to, a metallic ground plane and dielectric material at the very least.

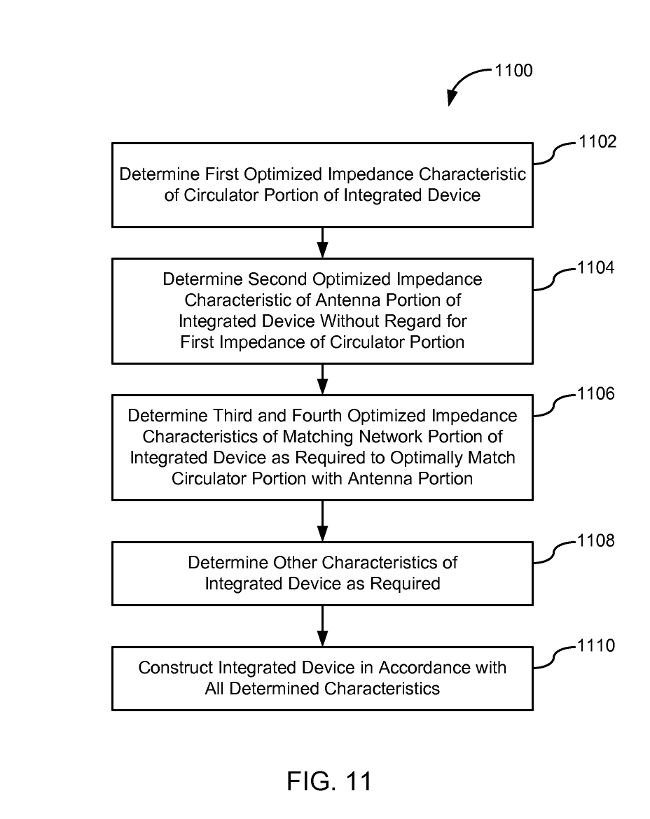

FIG. 11 depicts a flowchart 1100 including design method steps that are more particular than those described above in regard to the flowchart 1000 of FIG. 10. Again, the general topology and elemental constituency of such an integrated device is, for example, as depicted in FIG. 5, but the resulting integrated device is more specific and akin to the device 900 of FIG. 9.

The method of flowchart 1100 includes step 1102, wherein a first optimized impedance characteristic corresponding to a circulator portion of an integrated device is determined. For purposes of example, it is assumed that such impedance is analogous to the impedance Zi_{n,1} of FIG. 2. This impedance characteristic is considered a design element and is not known a prior.

At step 1104 of FIG. 11, a second optimized impedance characteristic corresponding to an antenna portion of the integrated device is determined (i.e., selected, or calculated) independently and without regard for the first impedance determined in step 1002 above. For purposes of ongoing example, it is assumed that such impedance is analogous to the impedance Zₐ of FIG. 2.

Next, in step 1106 of FIG. 11, third and fourth impedance characteristics corresponding to a matching network portion of the integrated device are determined. In this example, the matching network portion is considered analogous to M1 FIG. 2, while the third and fourth impedances are considered analogous to impedances Z₁, and Zₐ*, respectively, of FIG. 2. In one or more embodiments, the impedances are selected such that:

third impedance=complex conjugate of the first impedance; and

fourth impedance=complex conjugate of the second impedance.

In any case, the third and fourth impedances are determined such that the matching network portion optimally couples the circulator portion to the antenna portion of the integrated device.

In step 1108 of FIG. 11, other characteristics of the integrated device are determined as required and/or desired. For example, other matching network portions corresponding to connections between respective transmission line ports of the circulator portion and external interface ports of the integrated device can be determined.

In step 1110 of FIG. 10, the final integrated device is constructed in accordance with the all of the characteristics (impedances, etc.) determined in steps 1102-1108 above. As before, such an integrated device would typically comprise a metallic ground plane, a dielectric material supported on the ground plane, a ferrite puck received within the dielectric, and a metal layer (microstrip) layout in contacting support with the ferrite puck and dielectric material. Other elements, such as threaded connectors (coaxial, etc.), mounting holes, descriptive indicia, etc., can also be incorporated. In any case, the final integrated device incorporates circulator and antenna portions that share (i.e., are common to) at least a metallic ground plane and dielectric material.

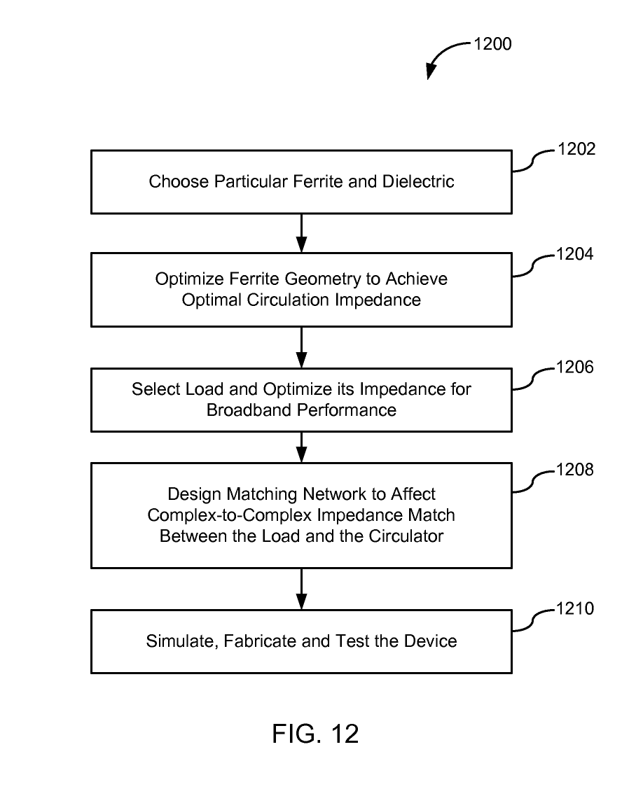

FIG. 12 depicts a flowchart 1200 including design method steps that are general and broadly applicable in accordance with the present teachings. As such, reference is not made to any specific figure.

In step 1202, a particular ferrite puck is selected in terms of saturation magnetization, coercivity, dielectric constant and/or other salient criteria. Additionally, an appropriate dielectric is selected to serve as the receiving “host” or substrate for the ferrite puck, as well as the balance of the device to be defined thereon.

In step 1204 of FIG. 12, the geometry of the selected ferrite puck is optimized. Such optimization can consider, among other things, thickness, coupling angle, puck radius, etc. This is done toward achieving an optimal circulation impedance response associated with equation 25 as presented above over the broadest range of frequencies possible and/or desirable for the design. As used here, an “optimal” design is one in which the real part of the impedance is virtually flat over the broadest range of frequencies, and the imaginary part is essentially zero over those same frequencies.

In step 1206, a load is selected and its impedance is optimized for broadband performance. By way of example, and not by limitation, an antenna is selected and optimized with respect to its complex impedance. Other loads and their respect impedances can also be selected and optimized in this regard. In any case, “broadband performance” is intended to mean designing the load so as to maximize (i.e., broaden) the frequency range over which that load will operate with satisfactory performance.

In step 1208, a matching network is designed that affects a complex-to-complex impedance match between the load (e.g., an antenna, etc.) and the circulation impedance over the broadest (maximized) range of frequencies, while monitoring the transducer power gain of the matching network. The matching network is designed so as to achieve the minimal acceptable value of transducer power gain over the frequency range of interest.

In step 1210 of FIG. 12, the overall design resulting from the steps 1202-1208 above is simulated (using finite elemental analysis or another suitable procedure), fabricated and tested. Thus, a broad and overall approach of the present teachings is performed.

### CONCLUSION

Design methods presented herein have generalized the requirements for perfect circulation by treating the load as part of the circulator design. In doing so, the flexibility of this approach has been exemplified in one embodiment by integrating a circulator with an antenna using a single matching network. That is, the present methodology allows for the design of a circulator/antenna module as a single device, rather than designing the two separately and conjoining them per some standardized impedance specification. The present methods result in designs that achieve wideband operation, efficient power transfer, good isolation and minimal extension in real estate. Prototype embodiments designed and constructed in accordance with the present methodologies proved to be practical in terms of initial design success—in the two exemplary cases presented above, there were no post-fabricating adjustments made to the respective prototypes.

What is claimed is:

1. A method of designing an integrated device, comprising:
determining a first impedance corresponding to a circulator portion of the integrated device according to a predetermined first optimality metric and a predetermined direction of circulation;
determining a second impedance corresponding to a microwave device portion of the integrated device according to a predetermined second optimality metric and the direction of circulation; and
determining a matching network portion of the integrated device such that the circulator portion is optimally coupled to the microwave device portion by way of the matching network portion.

2. The method of claim 1, further comprising determining a plurality of physical dimensions corresponding to a metal layer of the integrated device in accordance with the first and second impedances.

3. The method of claim 1, wherein:
the matching network is determined so as to affect a complex-to-complex impedance match between the circulator portion and the microwave device portion.

4. The method of claim 1, wherein at least one characteristic of the circulator portion of the integrated device is determined in accordance with the expression:
RₒS^{t}GₒS*=U,
where: Rₒ is a real impedance diagonal matrix corresponding to the circulator portion, S^{t} is the transpose of a transmission scattering parameter matrix corresponding to the circulator portion, Gₒ is the inverse of the matrix Rₒ, S* is determined by the expression: S*=(RₒS^{t G}ₒ)⁻¹, and U is the identity or unity matrix.

5. The method of claim 1, wherein at least one characteristic of the circulator portion of the integrated device is determined in accordance with one or the other of the expressions:
$${Z}_{1} = {Z}_{2} = {Z}_{3} = {R}_{o} \frac{{S}_{21} ( {S}_{11} + 1 ) - {S}_{31}^{2}}{{S}_{21} ( {S}_{11} - 1 ) - {S}_{31}^{2}} , \\ or$$
$${Z}_{1} = {Z}_{2} = {Z}_{3} = {R}_{o} \frac{{S}_{31} ( {S}_{11} + 1 ) - {S}_{21}^{2}}{{S}_{31} ( {S}_{11} - 1 ) - {S}_{21}^{2}} ,$$
where: Z₁, Z₂ and Z₃ are respective impedances corresponding to the circulator portion, Rₒ is a real impedance diagonal matrix corresponding to the circulator portion, and Sᵢⱼ are respective transmission scattering parameters corresponding to the circulator portion.

6. The method of claim 1, wherein at least one of the first and second impedances is further determined in accordance with an optimality metric selected so as to maximize a bandwidth performance.

7. The method of claim 6, wherein the bandwidth performance is further characterized by:
a standing-wave ratio characteristic of about 2:1 VSWR; and
a port isolation characteristic of at least 15 dB.

8. A method for designing an integrated device, comprising:
determining a first impedance corresponding to a circulator portion of the integrated device; and
determining a second impedance corresponding to a microwave device portion of the integrated device, the first and second impedances determined without regard for each other.

9. The method of claim 8, wherein the first and second impedances are determined in accordance with a metallic ground plane common to the circulator portion and the microwave device portion of the integrated device.

10. The method of claim 8, wherein the first and second impedances are determined in accordance with a predetermined transducer power gain to maximize bandwidth.

11. The method of claim 8, further comprising defining a first port and a second port of the integrated device, wherein the first and second impedances are determined such that:
the first port is electrically communicative with, and the second port is electrically isolated from, the microwave device during a first mode of operation; and
the first port is electrically isolated from, and the second port is electrically communicative with, the microwave device portion during a second mode of operation.

12. The method of claim 8, further comprising determining a matching network portion of the integrated device such that the circulator portion is cooperative with the microwave device portion by way of the matching network portion.

13. The method of claim 8, wherein the first impedance is neither equal to, nor the complex conjugate of, the second impedance.

14. The method of claim 8, wherein the microwave device portion of the integrated device is at least partially defined by an antenna, a mixer, a filter, a detector, or an amplifier.

15. The method of claim 8, wherein at least one of the first and second impedances is respectively determined so as to minimize an imaginary component thereof.

16. An integrated device, comprising:
a metallic platen;
a dielectric;
a ferrite puck; and
a metal layer, wherein the metallic platen, the dielectric, the ferrite puck and the metal layer are configured to define a circulator portion and a microwave device portion of the integrated device.

17. The device of claim 16, wherein:
the metallic platen, the dielectric, the ferrite puck and the metal layer are further configured to define a matching network portion of the integrated device; and
the circulator portion is cooperative with the microwave device portion by way of the matching network portion.

18. The device of claim 16, wherein the metallic platen, the dielectric, the ferrite puck and the metal layer are further configured in accordance with predetermined first and second impedances respectively corresponding to the circulator portion and the microwave device portion.

19. The device of claim 16, further comprising a first port and a second port of the integrated device, wherein:
the first port is electrically communicative with, and the second port is electrically isolated from, the microwave device portion during a first mode of operation; and
the first port is electrically isolated from, and the second port is electrically communicative with, the microwave device portion during a second mode of operation.

20. The device of claim 19, wherein:
the metallic platen, the dielectric, the ferrite puck and the metal layer are further configured to define a matching network portion of the integrated device; and
one or the other of the first port or the second port is coupled to the circulator portion by way of the matching network portion.

21. The device of claim 16, wherein the microwave device portion of the integrated device is at least partially defined by an antenna, a mixer, a filter, a detector, or an amplifier.

22. The device of claim 16, wherein the metallic platen, the dielectric, the ferrite puck and the metal layer are further configured such that:
the circulator portion is defined in accordance with a predetermined first impedance;
the microwave device portion is defined in accordance with a predetermined second impedance, the first and second impedances determined without regard for each other;
a matching network portion of the integrated device is defined; and
the circulator portion is coupled to the microwave device portion by way of the matching network portion.

23. The device of claim 22, wherein the first and second impedances are respectively determined in accordance with a predetermined optimality metric so as to maximize a bandwidth characteristic.

24. The device of claim 22, wherein at least one of the first and second impedances is respectively determined so as to minimize an imaginary component thereof.

25. The device of claim 16, wherein the circulator portion and the microwave device portion of the integrated device are simultaneously formed by way of the configuration of the metallic platen, the dielectric, the ferrite puck and the metal layer.

26. A method, comprising:
providing a unitary integrated device comprising:
a first port;
a second port;
a circulator portion; and
a microwave device portion, the circulator portion and the microwave device portion sharing a metallic ground plane of the unitary device.

27. The method of claim 26, further comprising:
during a first mode of operation, coupling the first port in signal communication with the microwave device portion and isolating the second port from signal communication with the microwave device portion by way of the circulator portion; and
during a second mode of operation, coupling the second port in signal communication with the microwave device portion and isolating the first port from signal communication with the microwave device portion by way of circulator portion.

28. A method, comprising:
selecting a particular ferrite puck and a dielectric substrate to receive the ferrite puck;
optimizing at least one geometrical aspect of the ferrite puck toward an optimal circulation impedance response;
determining a load impedance to cooperate with the circulation impedance; and
designing a matching network so as to affect a complex-to-complex impedance match between the load impedance and the circulation impedance.

29. The method of claim 28, wherein the optimizing at least one geometrical aspect of the ferrite puck includes determining at least one of a thickness of the ferrite puck, a coupling angle, or a puck radius.

30. The method of claim 28, wherein the designing the matching network includes minimizing a transducer power gain of the matching network over a maximized frequency range.

31. The method of claim 28, wherein the determining a load impedance is further defined by determining a load impedance of an antenna to cooperate with the circulation impedance.
